(19) United States
(12) Patent Application Publication
(10) Pub. No.: US 2012/0034414 A1
(43) Pub. Date: Feb. 9, 2012

(54) BORDERLESS EMBLEM FOR SECURING TO A FIRST FABRIC

(75) Inventor: Carl JURNOVOY, Philadelphia, PA (US)

(73) Assignee: PENN EMBLEM COMPANY, Philadelphia, PA (US)

(21) Appl. No.: 12/852,640

(22) Filed: Aug. 9, 2010

(51) Int. Cl. C09J 7/04; B32B 38/00; B32B 38/14; B32B 38/10; B32B 7/12; B32B 3/10

(52) U.S. Cl. 428/102; 428/196; 156/277; 156/60; 156/250

(57) ABSTRACT

A borderless emblem for being securing to a first fabric includes a fabric base having a front surface and a rear surface. The fabric base may be made of the same or substantially the same material as the first fabric and may have the same or substantially the same weave pattern and color as the first fabric. An emblem design is applied to the front surface of the fabric base. The emblem design may be embroidered or printed. A layer of thermoplastic adhesive material is bonded to the rear surface of the fabric base for securing the emblem to the first fabric. The outer peripheral edge of the fabric base is heat fused to finish the edge of the fabric base without including a stitched or other border.

### BACKGROUND OF THE INVENTION

The present invention relates to a borderless emblem and a method of making a borderless emblem and, in particular, to an emblem for securing to a first fabric using at least one of heat and pressure, the emblem having an embroidered or printed emblem design with no border around the outer peripheral edge and a method of making such an emblem.

In general, embroidered emblems and methods for making embroidered emblems are well known in the art. A particular embroidered emblem and method of making the embroidered emblem is disclosed in U.S. Pat. Nos. 3,657,060 entitled “Embroidered Emblem With Thermoplastic Adhesive” and 3,816,211 entitled “Method For Making Embroidered Emblem” both of which are owned by the assignee of the present application. These two related patents disclose an embroidered emblem 110 of the type shown in FIGS. 1 and 2 of the present application and which comprises a fabric base 112 with an embroidered design 114, including an embroidered border 114a extending around the outer periphery on at least a front or first principal surface 116 of the fabric base 112 and a layer of a thermoplastic adhesive material 118 laminated or bonded to the rear or second principal surface 120 of the fabric base 112. In this manner, the embroidered emblem 110 can be conveniently fastened to a garment or other fabric surface, referred to herein as a first fabric, through the application of at least one of heat and pressure to melt the thermoplastic material 118 and thereby bond the fabric base 112 to the first fabric such as a garment, hat or other fabric surface. A similar emblem and method is disclosed in U.S. Pat. No. 4,981,742. The subject matter of each of the three above-mentioned patents is hereby incorporated by reference into the present application.

While the emblems disclosed in the three above-mentioned patents are quite acceptable and while the methods disclosed in the above-referenced patents are quite useful in manufacturing such emblems, there was a need for an emblem which provides an enhanced appearance when secured to a garment or other fabric. In particular, there was a need for an embroidered emblem which has a fabric base which is the same as or substantially the same as the fabric of the garment or other fabric surface to which the emblem was to be secured so that when the embroidered emblem was secured to the garment or other fabric surface the fabric base blends in with the garment or other fabric surface so that it appears as though the embroidered design of the emblem was embroidered directly onto the garment or other fabric surface. For example, in some industries in which employees wear uniforms, the uniforms may have one or more embroidered emblems such as a company logo or employee name applied to the uniform shirt or jacket. Typically the names or other personalized information of the employees are embroidered directly onto the uniform shirt or jacket to provide a cleaner, neater appearance. Direct embroidery of an employee name in this manner adds substantial expense to the cost of the garment and, because removal of such direct embroidery is not feasible, precludes the garment from being re-used by another employee when the named employee leaves the company.

U.S. Pat. No. 7,467,593 entitled “Embroidered Emblem for Securing to a First Fabric” (owned by the assignee of the present application and incorporated herein by reference) discloses an embroidered emblem 210 (shown in FIGS. 3-5) which like the above described prior art embroidered emblems 110 includes a fabric base 212 having a front or first principal surface 216 and a rear or second principal surface 220, an embroidered design 214, including a border 214a, stitched or embroidered into at least the front surface 216 of the fabric base 212 and a layer of thermoplastic adhesive material 218 bonded to the rear surface 220 of the fabric base 212 for securing the emblem to the fabric 230 of a garment or other article. Unlike the above described prior art embroidered emblems 110, the embroidered emblem 210 of the '593 patent includes a fabric base 212 which is made of the same or substantially the same material as the fabric 230 (referred to as the “first fabric”) of the shirt, jacket, hat or other garment or article to which the emblem 210 is to be attached. In particular, the fabric base 212 of the embroidered emblem 210 includes the same or substantially the same weave pattern and color as the first fabric 230 so that when the emblem 210 is secured to the first fabric 230 (FIG. 5), the fabric base 212 of the emblem 210 blends with the first fabric 230 so that the fabric base 212 of the emblem 210 is nearly invisible and the embroidered emblem design 114 appears to have been applied directly to the garment or other article to which the emblem 210 has been secured.

There is also a substantial difference in the border 214a. With the above described prior art embroidered emblems 110, the embroidered border 114a, which is located around the outer or peripheral edge of the fabric base 112, is typically made at the same time as the remainder of the embroidered design 114 using the same needle, and a yarn color (typically a color used in the embroidered design) which typically contrasts with the color of the fabric base 112 and is of a thickness and/or width which corresponds to the thickness or width of the remainder of the embroidered design (see 114a of FIGS. 1 and 2 of the present application). In this manner, the border 114a serves as a frame to surround and highlight the fabric base 112 and the remainder of the embroidered design 114. In contrast, with the emblem 210 of the '593 patent, the stitched border 214a is made using a relatively small sized embroidery needle (much smaller that the needle used to make the remainder of the embroidered design 214) and is made using a yarn which is not the same as the yarn used to make the embroidered design 214. In particular, the yarn used to make the border 214a is relatively thin and is the same or substantially the same color as the color of the fabric base 212 and the first fabric 230. In this manner, when the emblem 210 is secured to the garment or other article (see FIG. 5), the much smaller sized border 214a fades into the fabric base 212 and the first fabric 230 of the garment or other article so that the border 214a is nearly invisible thus helping to give the appearance that the embroidered emblem design 214 has been applied directly to the first fabric 230 of the garment or other article.

The present invention provides an emblem which includes many of the features of the embroidered emblem 210 of the '593 patent. However, unlike the above described prior art emblems, an emblem in accordance with the present invention does not include an embroidered or stitched border or any other kind of border extending around the outer or peripheral edge of the fabric base. In this manner, an emblem made in accordance with the present invention, when applied to a garment or other article provides the appearance of the emblem design having been applied direct onto the garment or other article but is much easier to apply to the garment and can be conveniently and completely removed from the garment to permit re-use of the garment and the emblem. A borderless emblem in accordance with the present invention is also less expensive and easier to produce than an emblem which includes an embroidered or stitched border.

### BRIEF SUMMARY OF THE INVENTION

Briefly stated, in one embodiment the present invention is comprised of a borderless emblem for securing to a first fabric by the application of at least one of heat and pressure. The first fabric is made of a material having a predetermined weave pattern and at least one predetermined color. The emblem comprises a fabric base having a front surface, a rear surface and an outer peripheral edge, the fabric base being of the same or substantially the same material as the first fabric and having the same or substantially the same weave pattern and color as the first fabric. An emblem design is applied to the front surface of the fabric base. A layer of thermoplastic adhesive material is bonded to the rear surface of the fabric base for securing the emblem to the first fabric. The outer peripheral edge of the fabric base is heat fused to finish the edge of the fabric base without including a stitched or other border.

In another embodiment the present invention comprises a borderless emblem for securing to a first fabric by the application of at least one of heat and pressure. The emblem includes a fabric base having a front surface, a rear surface and an outer peripheral edge, an emblem design applied to the front surface of the fabric base and a layer of thermoplastic adhesive material bonded to the rear surface of the fabric base for securing the emblem to the first fabric. The outer peripheral edge of the fabric base is heat fused to finish the edge of the fabric base without including a stitched or other border.

In another embodiment the present invention comprises a method of making a borderless emblem for securing to a first fabric by the application of at least one of heat and pressure, the first fabric being made of a material having a predetermined weave pattern and at least one predetermined color. The method comprises: providing a fabric base having a front surface, a rear surface and an outer peripheral edge, the fabric base being of the same or substantially the same material as the first fabric and having the same or substantially the same weave pattern and color as the first fabric; applying an emblem design to the front surface of the fabric base; bonding a layer of thermoplastic adhesive material to the rear surface of the fabric base for securing the emblem to the first fabric; and heat fusing the outer peripheral edge of the fabric base to finish the edge without a stitched or other border.

In yet another embodiment the present invention comprises a method of making a borderless emblem for securing to a first fabric by the application of at least one of heat and pressure, the method comprising: providing a fabric base having a front surface, a rear surface and an outer peripheral edge; applying an emblem design to the front surface of the fabric base; bonding a layer of thermoplastic adhesive material to the rear surface of the fabric base for securing the emblem to the first fabric; and heat fusing the outer peripheral edge of the fabric base to finish the edge without a stitched or other border.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 is a top plan view of an embroidered emblem in accordance with the prior art;

FIG. 2 is a side sectional view of the prior art emblem shown in FIG. 1 taken along line 2-2 of FIG. 1;

FIG. 3 is a top plan view of another embroidered emblem in accordance with the prior art;

FIG. 4 is a side sectional view of the prior art emblem shown in FIG. 3 taken along line 4-4 of FIG. 3;

FIG. 5 is a top plan view of the prior art emblem shown in FIG. 3 after the emblem has been secured to a first fabric of a garment.

FIG. 6 is a top plan view of a borderless embroidered emblem in accordance with a first preferred embodiment of the present invention;

FIG. 7 is a side sectional view of the borderless embroidered emblem shown in FIG. 6 taken along line 7-7 of FIG. 6;

FIG. 8 is a top plan view of the borderless embroidered emblem shown in FIG. 6 after the emblem has been secured to a first fabric of a garment;

FIG. 9 is a top plan view of a borderless screen printed emblem in accordance with a second preferred embodiment of the present invention;

FIG. 10 is a side sectional view of the borderless screen printed emblem shown in FIG. 9 taken along line 10-10 of FIG. 9;

FIG. 11 is a top plan view of the borderless screen printed emblem shown in FIG. 9 after the emblem has been secured to a first fabric of a garment;

FIG. 12 is a side sectional view of a borderless ink jet printed emblem in accordance with a third preferred embodiment of the present invention; and

FIG. 12A is an enlarged view of the circled portion of FIG. 12.

### DETAILED DESCRIPTION OF THE INVENTION

Certain terminology is used in the following description for convenience only and is not limiting. The words “right,” “left,” “lower” and “upper” designate directions in the drawings to which reference is made. The words “inwardly” and “outwardly” refer to directions toward and away from, respectively, the geometric center of the emblem and designated parts thereof. Unless specifically set forth herein, the terms “a”, “an” and “the” are not limited to one element but instead should be read as meaning “at least one”. The terminology includes the words noted above, derivatives thereof and words of similar import.

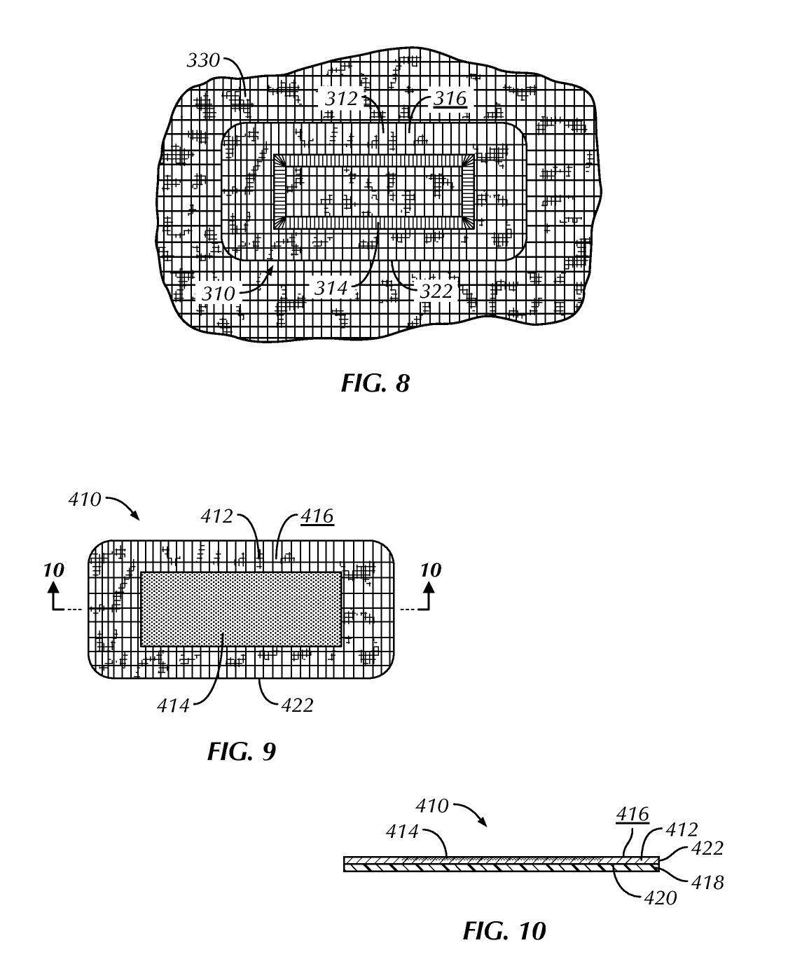

Referring to the drawings, there is shown in FIGS. 6, 7 and 8, a first preferred embodiment of an embroidered emblem, generally 310, for securing to a first fabric 330 by the application of at least one of heat and pressure in a manner as described in detail in the above-identified U.S. patents. The first fabric 330 may be a portion of a garment, such as a shirt, smock, apron, hat or any other article of clothing. Alternatively, the first fabric 330 may be a portion of some other article such as a banner, flag or any other article formed of the first fabric 330. Further, while it is preferred that the first fabric 330 be comprised of a woven textile fabric such as 100% polyester, 100% cotton or a polyester/cotton blend thereof, preferably about 65% polyester and about 35% cotton, it should be clearly understood that the first fabric 330 may be made of any type of natural or synthetic textile material using techniques which are known to those of ordinary skill in the art. In short, the first fabric 330 may comprise virtually any suitable woven fabric which may or may not be coated or impregnated with one or more soil resisting or stain repellent treatments and may be colored utilizing standard textile dyes of a type well known to those of ordinary skill in the art. The first fabric 330 as show in FIG. 8 is comprised of a textile material having a predetermined weave pattern and at least one predetermined color. The particular weave pattern utilized in forming the first fabric 330 should not be considered to be a limitation on the present invention nor should the particular color of the first fabric 330. Accordingly, it should be clearly understood that the embroidered emblem 310 in accordance with the present invention may be secured to a first fabric 330 having any type of weave pattern and any desired color without departing from the scope and spirit of the present invention.

As shown in FIGS. 6 and 7, the embroidered emblem 310 in accordance with the first preferred embodiment is comprised of a fabric base 312 having a first principal or front surface 316 and a second principal or rear surface 320. In the present embodiment the fabric base 312 is generally rectangularly shaped in plan view. It will be appreciated by those of ordinary skill in the art that the shape of the fabric base 312 as well as the size of the fabric base 312 may vary in particular applications. More specifically, the fabric base 312 may be circular, square, triangular, oblong, oval or any other desired shape. Preferably the fabric base 312 is made of a woven textile fabric such as 100% polyester or a polyester/cotton blend, preferably about 65% polyester and about 35% cotton. It will be appreciated that other types of woven textile fabrics may alternatively be used. As can be seen when viewing FIGS. 6 and 8, in the present embodiment the fabric base 312 preferably has the same or substantially the same weave pattern as that of the first fabric 330 and is of the same or substantially the same color as the color of the first fabric 330. More preferably, the fabric base 312 is made of the same or substantially the same material or fabric as the first fabric 330 so that when an embroidered emblem 310 in accordance with the first embodiment of the present invention is secured to the first fabric 330 the fabric base 312 precisely matches the first fabric 330 so that the fabric base 312 blends in with and substantially disappears into the first fabric 330. Alternatively, the fabric base 312 may have a weave pattern and/or color (not shown) which is different from the weave pattern/color of the first fabric 330 and/or the fabric base 312 may be made from a different material than the material of the first fabric 330 so that when the fabric base 312 is secured to the first fabric 330 the fabric base 312 stands out and is easily noticeable.

The emblem 310 further includes an emblem design 314 which has been embroidered into the front surface 316 of the fabric base 312 using a standard embroidery process in the manner well known in the art and as described in the above-identified patents. As best shown in FIG. 7, the embroidered emblem design 314 extends outwardly from the front surface 316 of the fabric base 312. As shown in FIGS. 6 and 9, for purposes of illustrating the present embodiment the embroidered emblem design 314 is in the form of a generally rectangular pattern. It will be appreciated by those of ordinary skill in the art that the generally rectangularly shaped embroidered emblem design 314 is presented only for purposes of illustrating the present invention and should not be considered to be a limitation on the present invention. Virtually any other type of embroidered emblem design including designs of different shapes and sizes, characters, names and the like as well as different colors or a combination of colors may alternatively be used.

The embroidered emblem 310 further includes a layer of thermoplastic adhesive material 318 which is laminated or bonded to the rear surface 320 of the fabric base 312. The thermoplastic adhesive material 318 is preferably a polyurethane which is the same as or substantially the same as the thermoplastic adhesive material described in detail in the above-identified patents and is bonded to the rear surface 320 of the fabric base 312 in the manner described in the above-identified U.S. patents. The layer of thermoplastic adhesive material 318 is used for securing the emblem 310 to the first fabric 330 by the application of at least one of heat and pressure in the manner described in detail in the above-identified U.S. patents.

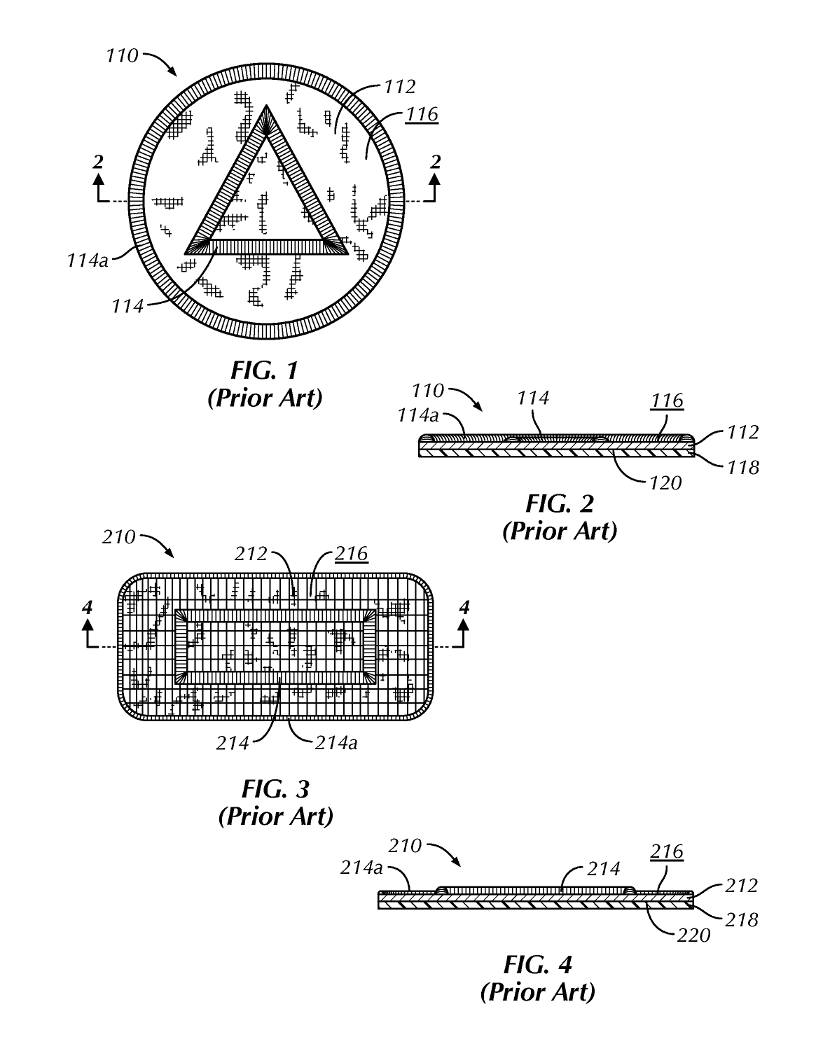

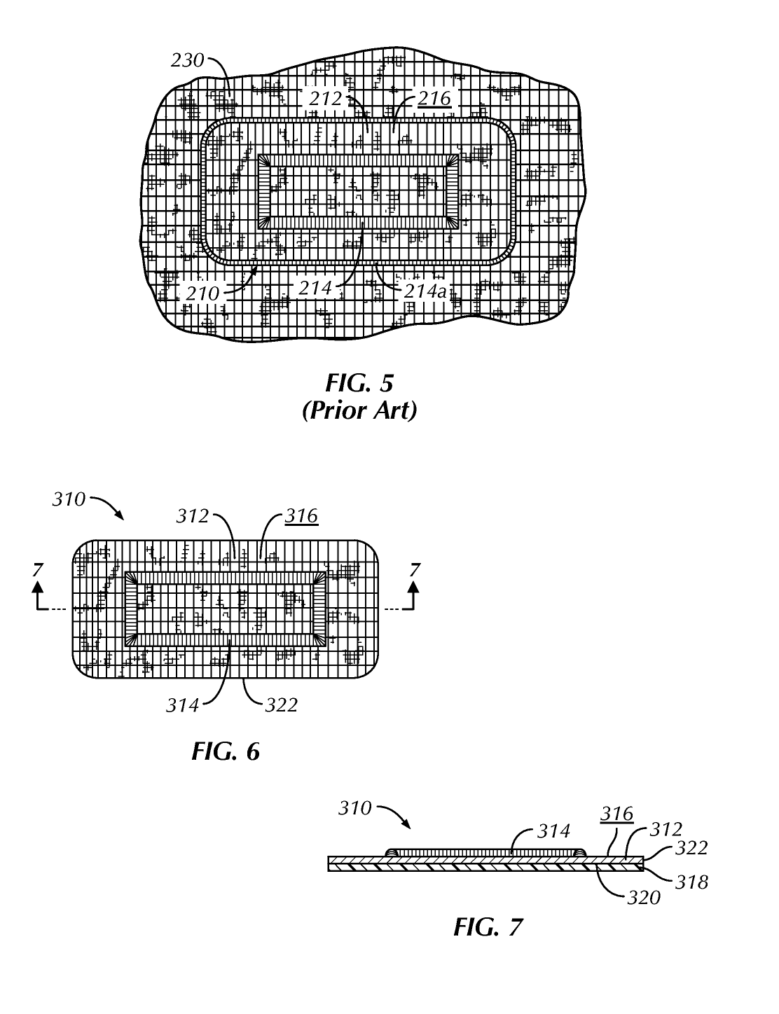

Typically, in the above described prior art embroidered emblem 110 the border 114a is a Merrow border which is typically made using a continuous filament 100% polyester extremely bright yarn typically in size 300/4's-1200 Denier. Typically a large needle, such as a number 3DST needle is used to make such a Merrow border. The Merrow border 114 is very heavy and broad. Typically the thread used to form the Merrow border 114a is a bright color which often contrasts with the color of the fabric base 112 so the border 114a frames and highlights the emblem 110 and particularly the emblem design 114 so it is quite visible as shown in FIGS. 1 and 2. The border 214a of the embroidered emblem 210, as described in the '593 patent, is also a stitched border which is made using a much smaller 100% spun polyester intentionally dull yarn in size Tex 27-60.5 Denier. The needle employed for forming the stitched border 214a is preferably a number DBXK5 needle which is much smaller than the needle used for the Merrow border 114a. By making a stitched border 214a utilizing a relatively small sized needle and by utilizing a relatively thin intentionally dull yarn which is the same or substantially the same color as that of the fabric base 212, the border 214a is relatively small and fades into the fabric base 212 and also fades into the first fabric 330 to become nearly invisible when the emblem 210 has been secured to the first fabric 230 as shown in FIG. 5. However, even the much smaller stitched border 214a of the prior art emblem 210 is still quite visible, particularly when the emblem 210 is secured to the first fabric 230.

The embroidered emblem 310 in accordance with the present invention is borderless. That is, unlike the above described prior art emblems 110 and 210, there is no embroidered border, stitched border or any other type of border extending around the outer or peripheral edge 322 of the fabric base 312. Instead, the outer edge 322 of the fabric base 312 is finished by subjecting the outer edge 322 to heat sufficient to effectively fuse a small portion of the polyester within the fabric base 312 proximate to the outer edge 322 to create a smooth finished edge 322 such that the ends of the fibers of the fabric base 312 are sealed to prevent unraveling during use or laundering. The fusing of the outer edge 322 of the fabric base 312 may be accomplished in any known manner, such as by exposing the edge 322 to a heat source, such as a heat gun. Preferably, the fabric base 312 is cut from a sheet of fabric, which may or may not contain multiple emblems, using a laser cutter such as a model 9050 available from CamFive Company which fuses the outer edge 322 as the fabric base 312 is cut. It will be apparent to those of ordinary skill in the art that any other suitable laser cutter may alternatively be used to cut the fabric base 312 from a sheet of fabric and simultaneously fuse the edge 322. Alternatively, the fabric base 312 may first be cut from the fabric sheet using some other cutting method, such as die cutting, and then the edge 322 may be subjected to a heat source to heat and fuse the polyester proximate to the edge 322.

FIG. 8 shows the embroidered emblem 310 in accordance with the first preferred embodiment secured to the first fabric 330. As can be seen, because the fabric base 312 is formed of the same or substantially the same material as the first fabric 330 and has the same or substantially the same weave pattern and color as the first fabric 330 and because the fabric base 312 does not include an embroidered or stitched border, the embroidered emblem 310 completely blends in with the first fabric 330 so as to be nearly invisible. In this manner, the emblem design 314 appears as though it has been embroidered directly onto the first fabric 330. Of course, as is well known in the art and as described in detail in the above-identified U.S. patents, the emblem 310 may be conveniently and cleanly removed from the first fabric 330 through the application of at least one of heat and pressure thereby permitting reuse of the first fabric 330 with our without the application of another emblem. As noted above, if the weave pattern and/or color of the fabric base 312 is different from that of the first fabric 330 the emblem 310 will stand out and be noticeable when secured to the first fabric 330.

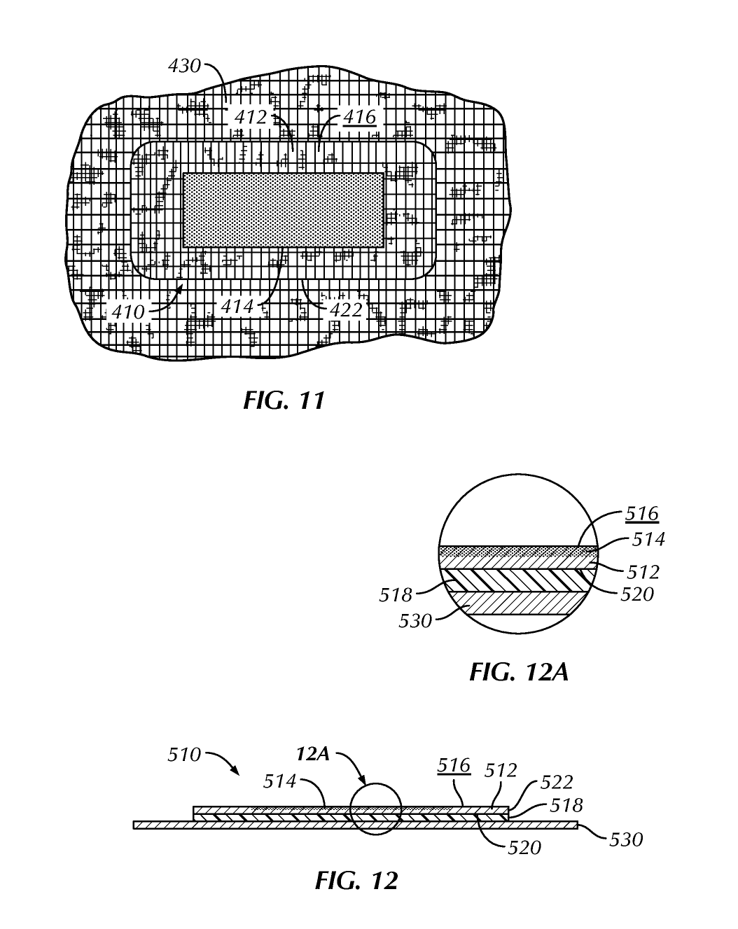

FIGS. 9, 10 and 11, show a second preferred embodiment of an emblem, generally 410, for securing to a first fabric 430 by the application of at least one of heat and pressure in a manner as described in detail in the above-identified U.S. patents and the first embodiment 310. The first fabric 430 shown in FIG. 11 is the same or substantially the same as the first fabric 330 described above and is comprised of a textile material having a predetermined weave pattern and at least one predetermined color. The particular weave pattern utilized in forming the first fabric 430 should not be considered to be a limitation on the present invention nor should the particular color of the first fabric 430. Accordingly, it should be clearly understood that the emblem 410 in accordance with the present invention may be secured to a first fabric 430 having any type of weave pattern and any desired color without departing from the scope and spirit of the present invention.

As shown in FIGS. 9 and 10, the emblem 410 in accordance with the second preferred embodiment is a screen printed emblem comprised of a fabric base 412 having a first principal or front surface 416 and a second principal or rear surface 420. In the present embodiment the fabric base 412 is generally rectangularly shaped in plan view. It will be appreciated by those of ordinary skill in the art that the shape of the fabric base 412 as well as the size of the fabric base 412 may vary in particular applications. More specifically, the fabric base 412 may be circular, square, triangular, oblong, oval or any other desired shape. Preferably the fabric base 412 is made of the same or substantially the same material as the fabric base 312 of the above-described first embodiment. As can be seen when viewing FIGS. 9 and 11, in the present embodiment the fabric base 412 preferably has the same or substantially the same weave pattern as that of the first fabric 430 and preferably is of the same or substantially the same color as the color of the first fabric 430. More preferably, the fabric base 412 is made of the same or substantially the same material or fabric as the first fabric 430 so that when a screen printed emblem 410 in accordance with the second embodiment of the present invention is secured to the first fabric 430 the fabric base 412 precisely matches the first fabric 430 so that the fabric base 412 blends in with and substantially disappears into the first fabric 430. Alternatively, the fabric base 412 may have a weave pattern and/or color (not shown) which is different from the weave pattern/color of the first fabric 430 and/or the fabric base 412 may be made from a different material than the material of the first fabric 430 so that when the fabric base 412 is secured to the first fabric 430 the fabric base 412 stands out and is easily noticeable.

The emblem 410 further includes an emblem design 414 which has been screen printed onto the front surface 416 of the fabric base 412 using a standard screen printing process in the manner well known in the art. As best shown in FIG. 10, the screen printed emblem design 414 essentially forms a thin layer on the front surface 416 of the fabric base 412. As shown in FIGS. 9 and 11, for purposes of illustrating the present embodiment the printed emblem design 414 is in the form of a generally rectangular pattern. It will be appreciated by those of ordinary skill in the art that the generally rectangularly shaped printed emblem design 414 is presented only for purposes of illustrating the present invention and should not be considered to be a limitation on the present invention. Virtually any other type of printed emblem design including designs of different shapes, sizes, characters and the like as well as different colors or a combination of colors may alternatively be used.

The emblem 410 further includes a layer of thermoplastic adhesive material 418 preferably a polyurethane, which is laminated or bonded to the rear surface 420 of the fabric base 412 in the manner described in the above-identified U.S. patents. The layer of thermoplastic adhesive material 418 is used for securing the emblem 410 to the first fabric 430 by the application of at least one of heat and pressure in the manner described in detail in the above-identified U.S. patents.

The screen printed emblem 410 in accordance with the second embodiment of the present invention is also borderless. Like the emblem 310 of the above described first embodiment, the outer edge 422 of the fabric base 412 is finished by subjecting the outer edge 422 to heat sufficient to effectively fuse a small portion of the polyester within the fabric base 412 proximate to the outer edge 422 to create smooth finished edge 422 such that the ends of the fibers of the fabric base 412 are sealed to prevent unraveling during use or laundering. The fusing of the outer edge 422 of the fabric base may be accomplished in any known manner, such described above. Preferably, the fabric base 412 is cut from a sheet of fabric, which may or may not contain multiple emblems, using a laser cutter such as a model 9050 available from CamFive Company which simultaneously fuses the edge 322.

FIG. 11 shows the screen printed emblem 410 in accordance with the second preferred embodiment secured to the first fabric 430. As can be seen, because the fabric base 412 is formed of the same or substantially the same material as the first fabric 430 and has the same or substantially the same weave pattern and color as the first fabric 430 and because the fabric base 412 does not include a border, the screen printed emblem 410 completely blends in with the first fabric 430 so as to be nearly invisible. In this manner, the emblem design 414 appears as though it has been printed directly onto the first fabric 430. As noted above, if the weave pattern and/or color of the fabric base 412 is different from that of the first fabric 430 the emblem 410 will stand out and be noticeable when secured to the first fabric 430.

FIGS. 12 and 12A show a third preferred embodiment of a printed emblem, generally 510, for securing to a first fabric 530 by the application of at least one of heat and pressure in a manner as described in detail in the above-identified U.S. patents. The printed emblem 510 is substantially the same as the above-described printed emblem 410 of the second embodiment with the exception of the manner in which the emblem design 514 is printed. More specifically, the emblem 510 includes a fabric base 512 which is made of the same or substantially the same material as the first fabric 530 to which the emblem 510 is to be attached and is preferably made of 100% polyester. Alternatively, the fabric base 512 could be made of a blend of polyester and cotton in the same manner as the above-described fabric base 412. The fabric base 512 includes a front surface 516, a rear surface 520 and a layer of thermoplastic adhesive material 518 bonded to the rear surface 520 as with the emblem 410 of the second embodiment 410. The fabric base 512 is also borderless and the outer edge 522 is finished in the same manner as described above with respect to the edge 422 of the fabric base 412 of the second embodiment 410. The only substantial difference between the emblems of the second embodiment 410 and the third embodiment 510 is that the emblem design 514 of the third embodiment is printed onto the front surface 516 of the fabric base 512 using an ink jet printing process.

The ink jet printing process used to apply the emblem design 514 to the front surface 516 of the fabric base 512 is of a type well known in the emblem making art. As best shown in FIG. 12A, the ink jet printed emblem design 514 is at least partially embedded into the fibers of the front surface 516 of the fabric base 512 to provide the emblem design 514 with an appearance which is slightly different from the appearance of the emblem design 414 of the second embodiment 410. Like the emblem 410 of the second embodiment, for purposes of illustrating the present embodiment the printed emblem design 514 is also in the form of a generally rectangular pattern. It will be appreciated by those of ordinary skill in the art that the generally rectangular shaped printed emblem design 514 is presented only for purposes of illustrating the present invention and should not be considered to be a limitation on the present invention. Virtually any other type of printed emblem design including designs of different shapes and sizes as well as different colors or a combination of colors may alternatively be used. In all other respects, the emblem 510 of the second embodiment is the same as the emblem 410 of the first embodiment.

It will be appreciated by those skilled in the art that changes could be made to the embodiments described above without departing from the broad inventive concepts thereof. It is understood, therefore, that this invention is not limited to the particular embodiments disclosed, but it is intended to cover all modifications within the spirit and scope of the present invention as defined by the appended claims.

I/we claim:

1. A borderless emblem for securing to a first fabric by the application of at least one of heat and pressure, the first fabric being made of a material having a predetermined weave pattern and at least one predetermined color, the emblem comprising:
a fabric base having a front surface, a rear surface and an outer peripheral edge, the fabric base being of the same or substantially the same material as the first fabric and having the same or substantially the same weave pattern and color as the first fabric;
an emblem design applied to the front surface of the fabric base; and
a layer of thermoplastic adhesive material bonded to the rear surface of the fabric base for securing the emblem to the first fabric,
wherein the outer peripheral edge of the fabric base is heat fused to finish the edge of the fabric base without including a stitched or other border.

2. A borderless emblem as recited in claim 1 wherein the emblem design is printed onto the front surface of the fabric base using one of a screen printing process and an ink jet printing process.

3. A borderless emblem as recited in claim 1 wherein the emblem design is embroidered into the front surface of the fabric base.

4. A borderless emblem as recited in claim 1 wherein the fabric base is comprised of a woven fabric selected from the group consisting of polyester and combinations of polyester and cotton.

5. A borderless emblem as recited in claim 4 wherein the fabric base is cut from the woven fabric utilizing a laser cutter which heats a portion of the polyester of the fabric base proximate the outer edge during the cutting process to fuse and finish the edge of the fabric base.

6. A borderless emblem as recited in claim 1 wherein the thermoplastic adhesive material is polyurethane.

7. A borderless emblem for securing to a first fabric by the application of at least one of heat and pressure, the emblem comprising:
a fabric base having a front surface, a rear surface and an outer peripheral edge;
an emblem design applied to the front surface of the fabric base; and
a layer of thermoplastic adhesive material bonded to the rear surface of the fabric base for securing the emblem to the first fabric,
wherein the outer peripheral edge of the fabric base is heat fused to finish the edge of the fabric base without including a stitched or other border.

8. A borderless emblem as recited in claim 7 wherein the emblem design is printed onto the front surface of the fabric base using one of a screen printing process and an ink jet printing process.

9. A borderless emblem as recited in claim 7 wherein the emblem design is embroidered into the front surface of the fabric base.

10. A borderless emblem as recited in claim 7 wherein the fabric base is comprised of a woven fabric selected from the group consisting of polyester and combinations of polyester and cotton.

11. A borderless emblem as recited in claim 10 wherein the fabric base is cut from the woven fabric utilizing a laser cutter which heats a portion of the polyester of the fabric base proximate the outer edge during the cutting process to fuse and finish the edge of the fabric base.

12. A borderless emblem as recited in claim 7 wherein the thermoplastic adhesive material is polyurethane.

13. A method of making a borderless emblem for securing to a first fabric by the application of at least one of heat and pressure, the first fabric being made of a material having a predetermined weave pattern and at least one predetermined color, the method comprising:
providing a fabric base having a front surface, a rear surface and an outer peripheral edge, the fabric base being of the same or substantially the same material as the first fabric and having the same or substantially the same weave pattern and color as the first fabric;
applying an emblem design to the front surface of the fabric base;
bonding a layer of thermoplastic adhesive material to the rear surface of the fabric base for securing the emblem to the first fabric; and
heat fusing the outer peripheral edge of the fabric base to finish the edge without a stitched or other border.

14. The method of making a borderless emblem as recited in claim 13 where the emblem design is printed onto the front surface of the fabric base using one of a screen printing process and an ink jet printing process.

15. The method of making a borderless emblem as recited in claim 13 where the emblem design is embroidered into the front surface of the fabric base.

16. The method of making a borderless emblem as recited in claim 13 wherein the fabric base is comprised of a woven fabric selected from the group consisting of polyester and combinations of polyester and cotton and wherein the fabric base is cut from the woven fabric utilizing a laser cutter which heats a portion of the polyester of the fabric base proximate the outer edge during the cutting process to fuse and finish the edge of the fabric base.

17. A method of making a borderless emblem for securing to a first fabric by the application of at least one of heat and pressure, the method comprising:
providing a fabric base having a front surface, a rear surface and an outer peripheral edge;
applying an emblem design to the front surface of the fabric base;
bonding a layer of thermoplastic adhesive material to the rear surface of the fabric base for securing the emblem to the first fabric; and
heat fusing the outer peripheral edge of the fabric base to finish the edge without a stitched or other border.

18. The method of making a borderless emblem as recited in claim 17 where the emblem design is printed onto the front surface of the fabric base using one of a screen printing process and an ink jet printing process.

19. The method of making a borderless emblem as recited in claim 17 where the emblem design is embroidered into the front surface of the fabric base.

20. The method of making a borderless emblem as recited in claim 17 wherein the fabric base is comprised of a woven fabric selected from the group consisting of polyester and combinations of polyester and cotton and wherein the fabric base is cut from the woven fabric utilizing a laser cutter which heats a portion of the polyester of the fabric base proximate the outer edge during the cutting process to fuse and finish the edge of the fabric base.
